(19) United States
(12) Patent Application Publication
(10) Pub. No.: US 2008/0087380 A1
(43) Pub. Date: Apr. 17, 2008

(54) Reactively-coupled articles and related methods

(75) Inventors: Miguel A. Prieto Goubert, Richterswil (CH); Peter Sandkuehler, Tarrangona (ES); Antonio Batistini, Wangen (CH); Sandra Hofmann, Hirzel (CH); Stephen F. Hahn, Midland, MI (US); Mohamed Esseghir, Monroe Township, NJ (US); Monika Plass, Buehl (DE); Mark F. Sonnenschein, Midland, MI (US); H. Craig Silvis, Midland, MI (US); Hamed Lakrout, Midland, MI (US); Kevin J. Bouck, Midland, MI (US)

Correspondence Address: The Dow Chemical Company, Intellectual Property Section, P.O. Box 1967, Midland, MI, 48641-1967, US

(73) Assignee: Dow Global Technologies Inc., Midland, MI (US)

(21) Appl. No.: 11/580,402

(22) Filed: Oct. 13, 2006

(51) Int. Cl. C09J 5/02; C08F 285/00

(52) U.S. Cl. 156/307.3; 521/163; 525/374; 525/452; 525/540

(57) ABSTRACT

The present invention is an article of construction formed from an article adhesively-bonded to a layering material through (a) reactive coupling of a functionalized nitroxide or (b) the adhesion of components in a polymer matrix made from or containing a polymer, an organic peroxide, and a functionalized nitroxide. The initial article may be expanded. The initial article may be expanded. It may also be polar or nonpolar. Similarly, the layering material may be polar or nonpolar. Other embodiments of the present invention are described, including other articles and methods for preparing the articles.

The useful articles of the present invention include shoe outsoles and midsoles, paints, overmolded articles, weather stripping, gaskets, profiles, durable goods, tires, construction panels, leisure and sports equipment foams, energy management foams, acoustic management foams, insulation foams, other foams, automotive parts (including bumper fascias, vertical panels, soft thermoplastic polyolefin skins, and interior trim), toys, supported films (including single-ply and co-extruded films), glass laminations, leather articles (synthetic and natural), personal health care and hygiene articles, other metal laminates, wood composites, and filled articles.

### FIELD OF THE INVENTION

The present invention relates to the reactive coupling of polymeric articles via (a) reactive coupling of functionalized, nitroxide-grafted polymers wherein the functional group provides the coupling site or (b) the adhesion of components in a polymer matrix made from or containing a polymer, an organic peroxide, and a functionalized nitroxide.

### DESCRIPTION OF THE PRIOR ART

Nonpolar polyolefins are used to a minor degree for shoe sole and mid-sole applications due to their poor adhesion to polar substrates. Blends of nonpolar polyolefins and polar polymers (such as copolymers of ethylene and unsaturated esters) are also limited in their use for the same reason. Notably, blends containing ethylene/vinyl acetate copolymers may also limit the balance of properties of final product, for example, in the areas of abrasion, service temperature, grip, and flexibility.

Accordingly, there is a need for polyolefin-based materials having improved adhesion to substrates such as leather (natural and synthetic) and other polar materials. Moreover, the need extends to adhering those polyolefin-based materials to those substrates by using polyurethane adhesives, without the use of special primers (like UV curing systems) or special surface treatment (like corona treatment). In particular, it is desirable for the adhesive system to be solvent or water borne.

Additionally, the aforementioned need includes improving the useful life, stability, and strength of the adhesive bond. It also desirable that the adhesion be substantially independent of the underlying polymer's crystallinity.

Furthermore, it is desirable that the process for adhering the polyolefin-based materials to the substrate proceed as rapidly as possible.

### SUMMARY OF THE INVENTION

The present invention is an article of construction formed from an article adhesively-bonded to a layering material through (a) reactive coupling of a functionalized nitroxide or (b) the adhesion of components in a polymer matrix made from or containing a polymer, an organic peroxide, and a functionalized nitroxide. The initial article may be expanded. It may also be polar or nonpolar. Similarly, the layering material may be polar or nonpolar. Other embodiments of the present invention are described, including other articles and methods for preparing the articles.

The useful articles of the present invention include shoe outsoles and midsoles, paints, overmolded articles, weather stripping, gaskets, profiles, durable goods, tires, construction panels, leisure and sports equipment foams, energy management foams, acoustic management foams, insulation foams, other foams, automotive parts (including bumper fascias, vertical panels, soft thermoplastic polyolefin skins, and interior trim), toys, supported films (including single-ply and co-extruded films), glass laminations, leather articles (synthetic and natural), personal health care and hygiene articles, other metal laminates, wood composites, and filled articles.

### DESCRIPTION OF THE INVENTION

In a first embodiment, the present invention is an article of construction prepared from (a) an article formed from a nitroxide-containing polymeric composition comprising a functionalized-nitroxide-grafted polymer wherein the functional group being a first functional group covalently-bonded to the nitroxide and available for reactively coupling to a second, complementary functional group; (b) an adhesive comprising a functionalized coupling agent having a second functional group capable of reactively coupling with the first functional group; and (c) a layering material adhesively-bonded to the formed article by reactively-coupling the second functional group of the adhesive with the first functional group of the functionalized-nitroxide-grafted polymer.

The functionalized-nitroxide-grafted polymer is prepared as the reaction product of a free-radical reaction of a functionalized nitroxide with a variety of polymers. Those polymers are preferably hydrocarbon-based and include such suitable polymers as ethylene/propylene/diene monomers, ethylene/propylene rubbers, ethylene/alpha-olefin copolymers, ethylene homopolymers, propylene homopolymers, ethylene/unsaturated ester copolymers, ethylene/styrene interpolymers, halogenated ethylene polymers, propylene copolymers, natural rubber, styrene/butadiene rubber, styrene/butadiene/styrene block copolymers, styrene/ethylene/butadiene/styrene copolymers, polybutadiene rubber, butyl rubber, chloroprene rubber, chlorosulfonated polyethylene rubber, ethylene/diene copolymer, and nitrile rubber, and blends thereof. The polymers may be nonpolar or polar.

With regard to the suitable ethylene polymers, the polymers generally fall into four main classifications: (1) highly-branched; (2) heterogeneous linear; (3) homogeneously branched linear; and (4) homogeneously branched substantially linear. These polymers can be prepared with Ziegler-Natta catalysts, metallocene or vanadium-based single-site catalysts, or constrained geometry single-site catalysts.

Highly branched ethylene polymers include low density polyethylene (LDPE). Those polymers can be prepared with a free-radical initiator at high temperatures and high pressure. Alternatively, they can be prepared with a coordination catalyst at high temperatures and relatively low pressures. These polymers have a density between about 0.910 grams per cubic centimeter and about 0.940 grams per cubic centimeter as measured by ASTM D-792.

Heterogeneous linear ethylene polymers include linear low density polyethylene (LLDPE), ultra-low density polyethylene (ULDPE), very low density polyethylene (VLDPE), and high density polyethylene (HDPE). Linear low density ethylene polymers have a density between about 0.850 grams per cubic centimeter and about 0.940 grams per cubic centimeter and a melt index between about 0.01 to about 100 grams per 10 minutes as measured by ASTM 1238, condition I. Preferably, the melt index is between about 0.1 to about 50 grams per 10 minutes. Also, preferably, the LLDPE is an interpolymer of ethylene and one or more other alpha-olefins having from 3 to 18 carbon atoms, more preferably from 3 to 8 carbon atoms. Preferred comonomers include 1-butene, 4-methyl-1-pentene, 1-hexene, and 1-octene.

Ultra-low density polyethylene and very low density polyethylene are known interchangeably. These polymers have a density between about 0.870 grams per cubic centimeter and about 0.910 grams per cubic centimeter. High density ethylene polymers are generally homopolymers with a density between about 0.941 grams per cubic centimeter and about 0.965 grams per cubic centimeter.

Homogeneously branched linear ethylene polymers include homogeneous LLDPE. The uniformly branched/homogeneous polymers are those polymers in which the comonomer is randomly distributed within a given interpolymer molecule and wherein the interpolymer molecules have a similar ethylene/comonomer ratio within that interpolymer.

Homogeneously-branched substantially linear ethylene polymers include (a) homopolymers of C₂-C₂₀ olefins, such as ethylene, propylene, and 4-methyl-1-pentene, (b) interpolymers of ethylene with at least one C₃-C₂₀ alpha-olefin, C₂-C₂₀ acetylenically unsaturated monomer, C₄-C₁₈ diolefin, or combinations of the monomers, and (c) interpolymers of ethylene with at least one of the C₃-C₂₀ alpha-olefins, diolefins, or acetylenically unsaturated monomers in combination with other unsaturated monomers. These polymers generally have a density between about 0.850 grams per cubic centimeter and about 0.970 grams per cubic centimeter. Preferably, the density is between about 0.85 grams per cubic centimeter and about 0.955 grams per cubic centimeter, more preferably, between about 0.850 grams per cubic centimeter and 0.920 grams per cubic centimeter.

Suitable ethylene/alpha-olefin interpolymers include those interpolymers: (a) having a Mw/Mn from about 1.7 to about 3.5, at least one melting point, Tm, in degrees Celsius, and a density, d, in grams/cubic centimeter, wherein the numerical values of Tm and d correspond to the relationship:

Tm>−2002.9+4538.5(d)−2422.2(d)²; or

(b) having a Mw/Mn from about 1.7 to about 3.5, and is characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH have the following relationships:

ΔT>−0.1299(ΔH)+62.81 for ΔH greater than zero and up to 130 J/g,

ΔT≧48° C. for ΔH greater than 130 J/g,

wherein the CRYSTAF peak is determined using at least 5 percent of the cumulative polymer, and if less than 5 percent of the polymer has an identifiable CRYSTAF peak, then the CRYSTAF temperature is 30° C.; or
(c) being characterized by an elastic recovery, Re, in percent at 300 percent strain and 1 cycle measured with a compression-molded film of the ethylene/α-olefin interpolymer, and has a density, d, in grams/cubic centimeter, wherein the numerical values of Re and d satisfy the following relationship when ethylene/a-olefin interpolymer is substantially free of a cross-linked phase:

Re>1481-1629(d); or

(d) having a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density, and molar comonomer content (based on the whole polymer) within 10 percent of that of the ethylene/α-olefin interpolymer; or
(e) having a storage modulus at 25° C., G′(25° C.), and a storage modulus at 100° C., G′(100° C.), wherein the ratio of G′(25° C.) to G′(100° C.) is in the range of about 1:1 to about 9:1.

Other useful ethylene/alpha-olefin interpolymer may (a) have a molecular fraction which elutes between 40° C. and 130° C. when fractionated using TREF, characterized in that the fraction has a block index of at least 0.5 and up to about 1 and a molecular weight distribution, Mw/Mn, greater than about 1.3; or

(b) have an average block index greater than zero and up to about 1.0 and a molecular weight distribution, Mw/Mn, greater than about 1.3.

Ethylene/styrene interpolymers useful in the present invention include substantially random interpolymers prepared by polymerizing an olefin monomer (i.e., ethylene, propylene, or alpha-olefin monomer) with a vinylidene aromatic monomer, hindered aliphatic vinylidene monomer, or cycloaliphatic vinylidene monomer. Suitable olefin monomers contain from 2 to 20, preferably from 2 to 12, more preferably from 2 to 8 carbon atoms. Preferred such monomers include ethylene, propylene, 1-butene, 4-methyl-1-pentene, 1-hexene, and 1-octene. Most preferred are ethylene and a combination of ethylene with propylene or C₄₋₈ alpha-olefins. Optionally, the ethylene/styrene interpolymers polymerization components can also include ethylenically unsaturated monomers such as strained ring olefins. Examples of strained ring olefins include norbornene and C₁₋₁₀ alkyl- or C₆₋₁₀ aryl-substituted norbornenes.

Ethylene/unsaturated ester copolymers useful in the present invention can be prepared by conventional high-pressure techniques. The unsaturated esters can be alkyl acrylates, alkyl methacrylates, or vinyl carboxylates. The alkyl groups can have 1 to 8 carbon atoms and preferably have 1 to 4 carbon atoms. The carboxylate groups can have 2 to 8 carbon atoms and preferably have 2 to 5 carbon atoms. The portion of the copolymer attributed to the ester comonomer can be in the range of about 5 to about 50 percent by weight based on the weight of the copolymer, and is preferably in the range of about 15 to about 40 percent by weight. Examples of the acrylates and methacrylates are ethyl acrylate, methyl acrylate, methyl methacrylate, t-butyl acrylate, n-butyl acrylate, n-butyl methacrylate, and 2-ethylhexyl acrylate. Examples of the vinyl carboxylates are vinyl acetate, vinyl propionate, and vinyl butanoate. The melt index of the ethylene/unsaturated ester copolymers can be in the range of about 0.5 to about 50 grams per 10 minutes.

Halogenated ethylene polymers useful in the present invention include fluorinated, chlorinated, and brominated olefin polymers. The base olefin polymer can be a homopolymer or an interpolymer of olefins having from 2 to 18 carbon atoms. Preferably, the olefin polymer will be an interpolymer of ethylene with propylene or an alpha-olefin monomer having 4 to 8 carbon atoms. Preferred alpha-olefin comonomers include 1-butene, 4-methyl-1-pentene, 1-hexene, and 1-octene. Preferably, the halogenated olefin polymer is a chlorinated polyethylene.

Examples of propylene polymers useful in the present invention include propylene homopolymers and copolymers of propylene with ethylene or another unsaturated comonomer. Copolymers also include terpolymers, tetrapolymers, etc. Typically, the polypropylene copolymers comprise units derived from propylene in an amount of at least about 60 weight percent. Preferably, the propylene monomer is at least about 70 weight percent of the copolymer, more preferably at least about 80 weight percent.

Natural rubbers suitable in the present invention include high molecular weight polymers of isoprene. Preferably, the natural rubber will have a number average degree of polymerization of about 5000 and a broad molecular weight distribution.

Useful styrene/butadiene rubbers include random copolymers of styrene and butadiene. Typically, these rubbers are produced by free radical polymerization or anionic solution polymerization. Styrene/butadiene/styrene block copolymers of the present invention are a phase-separated system. The styrene/ethylene/butadiene/styrene copolymers useful in the present invention are prepared from the hydrogenation of styrene/butadiene/styrene copolymers.

The polybutadiene rubber useful in the present invention is preferably a homopolymer of 1,4-butadiene. Preferably, the butyl rubber of the present invention is a copolymer of isobutylene and isoprene. The isoprene is typically used in an amount between about 1.0 weight percent and about 3.0 weight percent.

For the present invention, polychloroprene rubbers are generally polymers of 2-chloro-1,3-butadine. Preferably, the rubber is produced by an emulsion polymerization. Additionally, the polymerization can occur in the presence of sulfur to incorporate crosslinking in the polymer.

Preferably, the nitrile rubber of the present invention is a random copolymer of butadiene and acrylonitrile.

Other useful free-radical crosslinkable polymers include silicone rubbers and fluorocarbon rubbers. Silicone rubbers include rubbers with a siloxane backbone of the form —Si—O—Si—O—. Fluorocarbon rubbers useful in the present invention include copolymers or terpolymers of vinylidene fluoride with a cure site monomer to permit free-radical crosslinking.

Suitable functionalized nitroxides are hindered amine-derived stable organic free radicals and include derivatives of 2,2,6,6,-tetramethyl piperidinyl oxy (TEMPO). The first functional group is provided by the substituents of the nitroxide and available for reactively coupling to a second, complementary functional group. Preferably, hindered amine-derived stable organic free radicals are bis-TEMPOs, oxo-TEMPO, 4-hydroxy-TEMPO, an ester of 4-hydroxy-TEMPO, polymer-bound TEMPO, PROXYL, DOXYL, di-tertiary butyl N oxyl, dimethyl diphenylpyrrolidine-1-oxyl, 4 phosphonoxy TEMPO, 4-amine TEMPO, 4-isocyanate-TEMPO, or TEMPO derivatives containing primary hydroxyl groups.

Preferably, the functionalized nitroxide is present in an amount between about 0.05 weight percent to about 5.0 weight percent. More preferably, it is present between about 0.25 weight percent to about 2.0 weight percent.

Generally, the functionalized nitroxide is grafted onto the previously described polymers to form the functionalized-nitroxide-grafted polymers by using free-radical inducing species such as organic peroxides and Azo free radical initiators or radiation such as e-beaming. Organic peroxides can be added via direct injection. These free-radical inducing species may be used in combination with other free-radical initiators such as bicumene, oxygen, and air. Oxygen-rich environments can also initiate useful free-radicals. Examples of useful organic peroxides include di-(2-t-butylperoxy-isopropyl)benzene, dicumyl peroxide, t-butyl peroxybenzoate, 1,1-di(tert-butylperoxy)-3,3,5-trimethylcyclohexane, 2,5-dimethyl-2,5-di(tert-butylperoxy)hexyne-3, and 2,5-dimethyl-2,5-di(tert-butylperoxy) hexane. When selecting an organic peroxide, the relevant heat of activation should be considered because the relevant heat of activation may affect the peroxide's suitability for the particular article or its preparation.

Preferably, the free-radical inducing species is present in an amount between about 0.05 weight percent to about 5.0 weight percent, more preferably, between about 0.20 weight percent and 2.0 weight percent.

As alternative to organic peroxides, E-beam radiation, UV radiation, or temperature may be used to form the free radicals necessary for grafting the functionalized-nitroxide onto the polymer.

Preferably, the functionalized-nitroxide-grafted polymer was prepared under conditions of low shear rates and long residence times so that the resulting article can achieve desirable level of adhesions, but these parameters must be balanced against undesirable features such as premature crosslinking.

The composition for preparing the article identified as element (a), which composition comprises the functionalized-nitroxide-grafted polymer, may further comprise a blowing agent for yielding the article in an expanded form. The blowing agent can be a chemical or physical blowing agent. Preferably, the blowing agent will be a chemical blowing agent. An example of a useful chemical blowing agent is azodicarbonamide. Preferably, when the blowing agent is a chemical blowing agent, it is present in an amount between about 0.05 to about 6.0 phr. More preferably, it is present between about 0.5 to about 5.0 phr, even more preferably, between about 1.5 to about 3.0 phr.

The composition for preparing the article identified as element (a), which composition comprises the functionalized-nitroxide-grafted polymer, may further comprise a cure booster or a coagent to aid in crosslinking the formed article. Useful cure boosters include polyvinyl agents and certain monovinyl agents such as alpha methyl styrene dimer, allyl pentaerythritol (or pentaerythritol triacrylate), TAC, TAIC, 4-allyl-2-methoxyphenyl allyl ether, and 1,3-di-isopropenylbenzene. Other useful cure boosters include compounds having the following chemical structures.

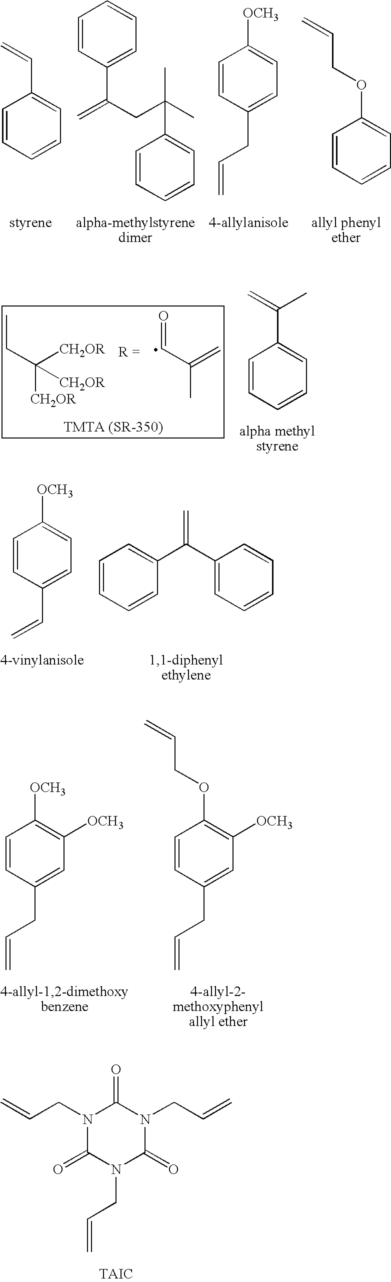

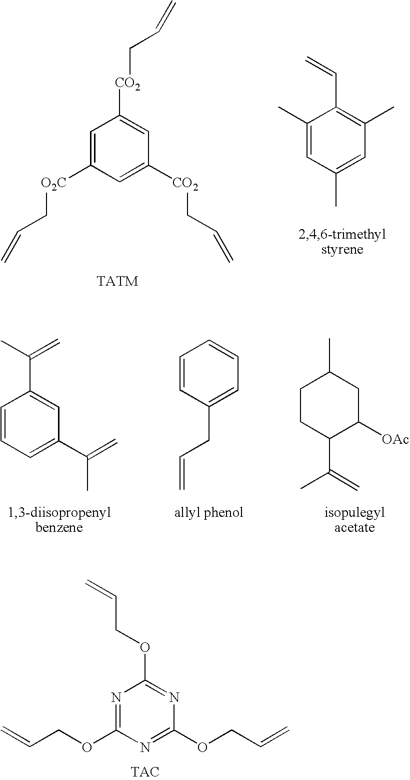

When the composition contains a cure booster, the cure booster is preferably present in an amount less than about 5.0 phr. More preferably, it is present between about 0.1 to about 4.0 phr, even more preferably, between about 0.2 to about 3.0 phr.

The adhesive, comprising a functionalized coupling agent having a second functional group capable of reactively coupling with the first functional group of the functionalized-nitroxide-grafted polymer, includes a variety of adhesives. Notable, examples include isocyanate-based adhesives when the first functional group is a hydroxyl or amino group.

The layering material can be a variety of substrates. Suitable examples include polar and nonpolar materials, such as paint, coatings, films, leather (natural and synthetic), glass, fibers (natural and synthetic), wood composites, filled substrates, engineering thermoplastics, thermoplastic elastomers, thermoplastic vulcanizates, nanocomposites, reinforced cement, and non-wovens.

When considering the article, the adhesive, and the layering material, the selection of conditions for adhering the article and the layering material can affect the quality of the adhesion. Accordingly, it is desirable to manage the heat of activation for the adhesion based upon such factors as the first functional group, the adhesive, and the second functional group.

The useful articles of the present invention include shoe outsoles and midsoles, paints, overmolded articles, weather stripping, gaskets, profiles, durable goods, tires, construction panels, leisure and sports equipment foams, energy management foams, acoustic management foams, insulation foams, other foams, automotive parts (including bumper fascias, vertical panels, soft thermoplastic polyolefin skins, and interior trim), toys, supported films (including single-ply and co-extruded films), glass laminations, leather articles (synthetic and natural), personal health care and hygiene articles, other metal laminates, wood composites, and filled articles.

In another alternate embodiment, the present invention is an article of construction prepared from (a) an article formed from a nitroxide-containing polymeric composition comprising a functionalized-nitroxide-grafted polymer wherein the functional group being a first functional group covalently-bonded to the nitroxide and available for reactively coupling to a second, complementary functional group and (b) an overmolding polymer matrix comprising an organic polymer having a second, complementary functional group capable of reactively-coupling with the first functional group of the functionalized-nitroxide-grafted polymer. The article described above with the first embodiment is equally suitable for use in this alternate embodiment.

The organic polymer can be a functionalized-derivative of a variety of organic polymers. Those organic polymers include the previously-described hydrocarbon-based polymers, including ethylene/propylene/diene monomers, ethylene/propylene rubbers, ethylene/alpha-olefin copolymers, ethylene homopolymers, propylene homopolymers, ethylene/unsaturated ester copolymers, ethylene/styrene interpolymers, halogenated ethylene polymers, propylene copolymers, natural rubber, styrene/butadiene rubber, styrene/butadiene/styrene block copolymers, styrene/ethylene/butadiene/styrene copolymers, polybutadiene rubber, butyl rubber, chloroprene rubber, chlorosulfonated polyethylene rubber, ethylene/diene copolymer, and nitrile rubber, and blends thereof.

Other useful functionalized organic polymers, depending upon the first functional group, include polyols, polyisocyanates, polyamines, and others.

When considering the article and the overmolding polymer matrix, the selection of conditions for reactively-coupling the article and the overmolding polymer matrix can affect the quality of the coupling bond. Accordingly, it is desirable to manage the heat of activation for the reactive coupling based upon such factors as the first functional group and the second functional group.

In yet another embodiment, the present invention can be a method for preparing a laminated article of construction comprising the steps of (a) forming an article of construction using a nitroxide-containing polymeric composition comprising a functionalized-nitroxide-grafted polymer, wherein the functional group being a first functional group covalently-bonded to the nitroxide and available for reactively coupling to a second, complementary functional group; (b) selecting a layering material for adhesively-binding to the formed article; (c) applying an adhesive to the desired binding surface of (1) the formed article of construction or (2) the layering material, wherein the adhesive comprises a functionalized coupling agent having a second functional group capable of reactively coupling with the first functional group; (d) proximately placing the article of construction and the layering material such that the adhesive affixes the article and the layering material to each other; and (e) reactively-coupling the second functional group of the adhesive with the first functional group of the functionalized-nitroxide-grafted polymer to adhesively bind the layering material to the article.

In another embodiment, the present invention is a method for preparing a coated article of construction comprising the steps of (a) forming an article of construction using a nitroxide-containing polymeric composition comprising a functionalized-nitroxide-grafted polymer, wherein the functional group being a first functional group covalently-bonded to the nitroxide and available for reactively coupling to a second, complementary functional group; (b) selecting a coating material for adhesively-binding to the formed article; (c) applying an adhesive to the desired binding surface of the formed article of construction, wherein the adhesive comprises a functionalized coupling agent having a second functional group capable of reactively coupling with the first functional group; (d) applying the coating material to the article's surface upon which the adhesive was applied in Step (c), and (e) reactively-coupling the second functional group of the adhesive with the first functional group of the functionalized-nitroxide-grafted polymer to adhesively bind the coating to the formed article.

In this embodiment the coating material can be any material desirable for adhering to the article. Suitable examples include paints, coverings, and insulative materials. The coating may contain a functional group suitable for reactively coupling with the first, the second, or both functional groups.

In another embodiment, the present invention is a method for preparing an overmolded article of construction comprising the steps of (a) forming an article of construction using a nitroxide-containing polymeric composition comprising a functionalized-nitroxide-grafted polymer, wherein the functional group being a first functional group covalently-bonded to the nitroxide and available for reactively coupling to a second, complementary functional group; (b) selecting an overmolding polymer matrix comprising an organic polymer having a second, complementary functional group capable of reactively-coupling with the first functional group of the functionalized-nitroxide-grafted polymer; (c) applying the overmolding polymer matrix to the desired binding surface of the formed article of construction; and (d) reactively-coupling the second functional group of the overmolding polymer matrix with the first functional group of the functionalized-nitroxide-grafted polymer to bind the overmolding polymer matrix to the article.

In yet another embodiment, the present invention is an article of construction formed from an article adhesively-bonded to a layering material through the adhesion of components in a polymer matrix made from or containing a polymer, an organic peroxide, and a functionalized nitroxide. In this embodiment, the polymer matrix is used to form the article. The previously-described polymers, organic peroxides, and functionalized nitroxides are useful in this embodiment.

Specifically, the invention of this embodiment is an article of construction prepared from (a) an article formed from a polymer matrix made from or containing a polymer, an organic peroxide, and a functionalized nitroxide, wherein the functional group being a first functional group covalently-bonded to the nitroxide and available for reactively coupling to a second, complementary functional group; (b) an adhesive comprising a functionalized coupling agent having a second functional group capable of reactively coupling with the first functional group; and (c) a layering material adhesively-bonded to the formed article by reactively-coupling the second functional group of the adhesive with the first functional group of the polymer matrix. Alternatively, this embodiment includes an article of construction prepared from (a) an article formed from a polymer matrix made from or containing a polymer, an organic peroxide, and a functionalized nitroxide, wherein the functional group being a first functional group covalently-bonded to the nitroxide and available for reactively coupling to a second, complementary functional group and (b) an overmolding polymer matrix comprising an organic polymer having a second, complementary functional group capable of reactively-coupling with the first functional group of the functionalized-nitroxide-grafted polymer.

### EXAMPLES

The following non-limiting examples illustrate the invention.

### Example 1 and Comparative Example 2

A functionalized nitroxide-grafted polymer was prepared from Affinity EG8200 ethylene/1-octene copolymer, 4-hydroxy-TEMPO, and Perkadox 1440™ di(tert-butylperoxyisopropyl)benzene. The ethylene/1-octene copolymer had a melt index of 5.0 decigrams per minute and a density of 0.87 grams per cubic centimeter and was available from The Dow Chemical Company. The 4-hydroxy-TEMPO was commercially available from A. H. Marks. Perkadox 1440™ di(tert-butylperoxyisopropyl)benzene was the peroxide used to initiate the free-radical grafting of the 4-hydroxy-TEMPO onto the ethylene/1-octene copolymer. Perkadox 1440™ di(tert-butylperoxyisopropyl)benzene had a nominal decomposition temperature (temperature at which 90% of the peroxide is decomposed in a 12-minute period) of 175 degrees Celsius and a half life of 94 minutes at 140 degrees Celsius. It was commercially available from Akzo Nobel Chemicals BV.

The functionalized nitroxide-grafted polymer was prepared in a lab twin screw extruder (Polylab) by feeding a dry blend of 5 percent by weight (“pbw”) 4-hydroxy-TEMPO, 10 pbw Perkadox 1440™ di(tert-butylperoxyisopropyl)benzene, and 85 pbw Affinity EG8200 ethylene/1-octene copolymer at 130 degrees Celsius to render a masterbatch. The masterbatch was diluted with additional ethylene/1-octene copolymer in a second run at 130 degrees Celsius to a composition containing 1 pbw 4-hydroxy-TEMPO and 2 pbw Perkadox 1440™ di(tert-butylperoxyisopropyl)benzene.

The resulting composition was reacted in the Polylab by raising the temperature towards 180 degrees Celsius at a feed rate of 2 kg/h and 150 rpm. The resulting functionalized nitroxide-grafted polymer (Example 1) was pelletized and compression molded at 120 degrees Celsius to render plaques suitable for further testing.

The Example 1 functionalized nitroxide-grafted polymer was evaluated for adhesion with the use of a polyurethane adhesive to a polyester fabric. The exemplified test specimen exhibited a grafting at the level of 0.138 weight percent as determined by Fourier Transform Infrared Analysis (“FTIR”). Example 1 demonstrated an adhesion of 5.738 N/mm as measured by DIN 53357 A. The comparative test specimen (Comparative Example 2) was prepared using the same copolymer, except it was not grafted with the functionalized-nitroxide. Comparative Example 2 did not demonstrate any adhesion.

### Solvent-Borne Adhesion:

### Examples 3-5, 8-10 and Comparative Examples 6, 7, and 11

Test specimens were prepared of functionalized-nitroxide-grafted polymers made from ethylene polymers available from The Dow Chemical Company: (1) Affinity EG8200 and (2) Affinity PF 1140G. Affinity PF 1140G polyethylene had a melt index of 1.6 decigrams per minute and a density of 0.897 grams per cubic centimeter. The functionalized-nitroxide-grafted polymers were prepared using the same method described with regard to Example 1 above. The underlying substrates were leather strips.

A comparative example used thermoplastic polyurethane sheets made from Pellethane 2355-80AE thermoplastic polyurethane (which was available from The Dow Chemical Company) as the polymer rather than an ethylene polymer.

| | pbw |
|---|---|
| Primer A | |
| methyl-ethyl ketone | 100 |
| polyurethane adhesive (solvent borne) | 50 |
| poly-isocyanate crosslinker (solvent borne) | 25 |
| Adhesive B | |
| polyurethane adhesive (solvent borne) | 100 |
| poly-isocyanate crosslinker (solvent borne) | 5 |

The split side of the leather was abraded with sandpaper rotating disk machine to unify and shorten the fibers. The polymer surfaces were abraded and roughened with sandpaper of grade 60 and subsequently wiped clean with toluene.

Primer A was applied to the polymer substrates with a brush two times and to the leather with a pipette soaking the leather. Polymer substrates were then dried in an oven at <50 degrees Celsius for 10 minutes. The leather samples are dried at <50 degrees Celsius only until they were dry.

After the substrates were allowed to cool down, Adhesive B was applied with a brush on both substrates. The Affinity EG 8200 polymer substrate was heated for 5 minutes at 90 degrees Celsius, the Affinity PF 1140 G polymer substrate was heated for 5 minutes at 115-120 degrees Celsius, and the leather substrate was heated for only 1 minute at 90 degrees Celsius. The thermoplastic polyurethane sheets were heated in the oven at 115 degrees Celsius for 5 minutes. The substrates were pressed against each other for good contact. Finally, they were pressed between two foams of 10-centimeter thickness in the hot press at 20 degrees Celsius and 10 bar for 1 min. The samples were left at least overnight for curing.

Delamination and adhesive forces, respectively, were measured on the Zwick Tensile Z010 model with a 10 kN load cell. The test speed was 100 mm/min and the cut specimen strips are 15×100 mm.

TABLE 1

| | Ex 3 | Ex 4 | Ex 5 | Com. Ex 6 | Com. Ex 7 |
|---|---|---|---|---|---|
| Affinity EG8200 | 100 | 100 | 100 | 100 | 100 |
| 4-hydroxy-TEMPO | 1 | 0.5 | 0.25 | 0 | 0 |
| Perkadox 1440 | 2 | 1 | 0.5 | 0 | 3.3 |
| Delamination force | 6.69 | 4.97 | 5.59 | 1.15 | 0.99 |
| [N/mm] | | | | | |

TABLE 2

| | Ex 8 | Ex 9 | Ex 10 | Com. Ex 11 |
|---|---|---|---|---|
| thermoplastic polyurethane | | | | 100 |
| sheet | | | | |
| Affinity PF 1140 | 100 | 100 | 100 | 0 |
| 4-hydroxy-TEMPO | 0.5 | 1 | 0.5 | 0 |
| Perkadox 1440 | 1 | 1 | 0.6 | 0 |
| Delamination force [N/mm] | 4.04 | 4.00 | 4.49 | 3.96 |

### Water-Borne Adhesion: Examples 12-13

Test specimens were prepared of functionalized-nitroxide-grafted polymers made from ethylene polymers available from Affinity EG8200. The functionalized-nitroxide-grafted polymer was prepared using the same method described with regard to Example 1 above. The underlying substrates were leather strips.

| Adhesive C | pbw |
|---|---|
| polyurethane adhesive (water borne) | 100 |
| block poly-isocyanate (water borne) | 5 |

The surfaces of the polymer were abraded and cleaned with toluene. The leather was abraded. The polymer surface was primed with a thin layer of a polyisocyanate-diol prepolymer with a brush and dried at 75 degrees Celsius for 40 min. Adhesive C was brushed onto the leather surface and onto the polymer surface and both polymer and leather are dried for 1 hour at 40 degrees Celsius. Both were taken out of the oven, the oven was heated up to 90 degrees Celsius and polymer and leather are activated for 1.5 min at 90 degrees Celsius. They were then forced together with mild hammering and pressed in the hot press for 1 min at 20 degrees Celsius and 10 bar.

Delamination and adhesive forces, respectively, were measured on the Zwick Tensile Z010 model with a 10 kN load cell. The test speed was 100 mm/min and the cut specimen strips are 15×100 mm.

TABLE 3

| | Ex 12 | Ex 13 |
|---|---|---|
| Affinity EG8200 | 100 | 100 |
| 4-hydroxy-TEMPO | 1 | 1 |
| Perkadox 1440 | 2 | 2 |
| Delamination force [N/mm] | 4.77 | 5.31 |

### Over-Molding: Examples 14-15 and Comparative Example 16

A reacting mixture of diol and isocyanate was applied to the surface of a functionalized material. The isocyanate was mixed with the diol with a ratio of 1.0 or 1.1 per functionality (excess of isocyanate) and poured in a handmade mold over the respective functionalized material.

Samples of functionalized material were primed with a polyisocyanate-diol prepolymer. The polyisocyanate-diol prepolymer was applied at room temperature, and the polymer was held at 70 degrees Celsius in an oven for 40 min. The cooled down samples were then over-molded. The adhesion was significant, and the interface could not be separated manually. Samples with untreated polyolefin could be separated from the polyurethane by hand.

TABLE 4

| | Ex 14 | Ex 15 | Com. Ex 16 |
|---|---|---|---|
| Affinity EG 8200 | 100 | 100 | 100 |
| 4-hydroxy-TEMPO | 0.5 | 1 | 0 |
| Perkadox 1440 | 0.5 | 1 | 0 |
| Polymers separable by hand | No | No | Yes |

What is claimed is:

1. An article of construction prepared from
(a) an article formed from a nitroxide-containing polymeric composition comprising a functionalized-nitroxide-grafted polymer wherein the functional group being a first functional group covalently-bonded to the nitroxide and available for reactively coupling to a second, complementary functional group;
(b) an adhesive comprising a functionalized coupling agent having a second functional group capable of reactively coupling with the first functional group; and
(c) a layering material adhesively-bonded to the formed article by reactively-coupling the second functional group of the adhesive with the first functional group of the functionalized-nitroxide-grafted polymer.

2. An article of construction prepared from
(a) an article formed from a nitroxide-containing polymeric composition comprising a functionalized-nitroxide-grafted polymer wherein the functional group being a first functional group covalently-bonded to the nitroxide and available for reactively coupling to a second, complementary functional group and
(b) an overmolding polymer matrix comprising an organic polymer having a second, complementary functional group capable of reactively-coupling with the first functional group of the functionalized-nitroxide-grafted polymer.

3. The article of construction of claims 1 or 2 wherein the nitroxide-grafted polymer of the polymeric composition is a polyolefin or blends thereof.

4. The polymeric composition according to claim 3 wherein the nitroxide-grafted polymer being nonpolar.

5. The article of construction of claims 1 or 2 wherein the reactively-coupled bond is a urethane linkage.

6. The article of construction of claim 5 wherein the first functional group being a hydroxyl group or an isocyanate group.

7. The article of construction of claims 1 or 2 wherein the functionalized nitroxide being selected from the group of 4-hydroxy TEMPO, 4-amino TEMPO, 4-isocyanate TEMPO, and TEMPO derivatives containing primary hydroxyl groups.

8. The article of construction of claims 1 or 2 wherein the nitroxide-containing polymeric composition further comprises a blowing agent.

9. The article of construction of claim 1 wherein the layering material has a first surface for adhering to the formed article and that first surface being polar.

10. The article of construction of claim 1 wherein the layering material being selected from the group consisting of natural substrates, polar substrates, paint, coatings, films, fibers, composites, and metal substrates.

11. A method for preparing a laminated article of construction comprising the steps of:
(a) forming an article of construction using a nitroxide-containing polymeric composition comprising a functionalized-nitroxide-grafted polymer, wherein the functional group being a first functional group covalently-bonded to the nitroxide and available for reactively coupling to a second, complementary functional group;
(b) selecting a layering material for adhesively-binding to the formed article;
(c) optionally, applying a primer to the desired binding surface of (1) the formed article of construction or (2) the layering material;
(d) applying an adhesive to the desired binding surface of (1) the formed article of construction or (2) the layering material, wherein the adhesive comprises a functionalized coupling agent having a second functional group capable of reactively coupling with the first functional group;
(e) proximately placing the article of construction and the layering material such that the adhesive affixes the article and the layering material to each other; and
(f) reactively-coupling the second functional group of the adhesive with the first functional group of the functionalized-nitroxide-grafted polymer to adhesively bind the layering material to the article.

12. A method for preparing a coated article of construction comprising the steps of:
(a) forming an article of construction using a nitroxide-containing polymeric composition comprising a functionalized-nitroxide-grafted polymer, wherein the functional group being a first functional group covalently-bonded to the nitroxide and available for reactively coupling to a second, complementary functional group;
(b) selecting a coating material for adhesively-binding to the formed article;
(c) optionally, applying a primer to the desired binding surface of the formed article of construction;
(d) applying an adhesive to the desired binding surface of the formed article of construction, wherein the adhesive comprises a functionalized coupling agent having a second functional group capable of reactively coupling with the first functional group;
(e) applying the coating material to the article's surface upon which the adhesive was applied in Step (c), and
(f) reactively-coupling the second functional group of the adhesive with the first functional group of the functionalized-nitroxide-grafted polymer to adhesively bind the coating to the formed article.

13. A method for preparing an overmolded article of construction comprising the steps of:
(a) forming an article of construction using a nitroxide-containing polymeric composition comprising a functionalized-nitroxide-grafted polymer, wherein the functional group being a first functional group covalently-bonded to the nitroxide and available for reactively coupling to a second, complementary functional group;
(b) selecting an overmolding polymer matrix comprising an organic polymer having a second, complementary functional group capable of reactively-coupling with the first functional group of the functionalized-nitroxide-grafted polymer;
(c) applying the overmolding polymer matrix to the desired binding surface of the formed article of construction; and
(d) reactively-coupling the second functional group of the overmolding polymer matrix with the first functional group of the functionalized-nitroxide-grafted polymer to bind the overmolding polymer matrix to the article.

14. An article of construction prepared from
a. an article formed from a polymer matrix made from or containing a polymer, an organic peroxide, and a functionalized nitroxide, wherein the functional group being a first functional group covalently-bonded to the nitroxide and available for reactively coupling to a second, complementary functional group;
b. an adhesive comprising a functionalized coupling agent having a second functional group capable of reactively coupling with the first functional group; and
c. a layering material adhesively-bonded to the formed article by reactively-coupling the second functional group of the adhesive with the first functional group of the polymer matrix.

15. An article of construction prepared from
(a) an article formed from a polymer matrix made from or containing a polymer, an organic peroxide, and a functionalized nitroxide, wherein the functional group being a first functional group covalently-bonded to the nitroxide and available for reactively coupling to a second, complementary functional group and
(b) an overmolding polymer matrix comprising an organic polymer having a second, complementary functional group capable of reactively-coupling with the first functional group of the functionalized-nitroxide-grafted polymer.
